(19) United States
(12) Patent Application Publication
(10) Pub. No.: US 2015/0127757 A1
(43) Pub. Date: May 7, 2015

(54) Systems and Methods for Sending Messages

(71) Applicant: Tencent Technology (Shenzhen) Company Limited, Shenzhen (CN)

(72) Inventors: Li Liu, Shenzhen (CN); Jun Shu, Shenzhen (CN); Ming Tian, Shenzhen (CN); Yao Wang, Shenzhen (CN); Hui Wang, Shenzhen (CN)

(21) Appl. No.: 14/592,314

(22) Filed: Jan. 8, 2015

Related U.S. Application Data
(63) Continuation of application No. PCT/CN2014/082369, filed on Jul. 17, 2014.

(30) Foreign Application Priority Data
Aug. 16, 2013 (CN) 201310359616.3

(51) Int. Cl. H04L 12/58

(52) U.S. Cl. CPC H04L 51/16
USPC 709/206

(57) ABSTRACT

Devices and methods are provided for sending messages. For example, a receiving user list corresponding to a specific message to be sent is acquired; a first timeline refresh request associated with a first receiving user in the receiving user list is received; and upon the capture of the first timeline refresh request, the specific message is sent to a client associated with the first receiving user that refreshes a timeline.

### CROSS-REFERENCES TO RELATED APPLICATIONS

The application claims priority to Chinese Patent Application No. 201310359616.3, filed Aug. 16, 2013, incorporated by reference herein for all purposes.

### BACKGROUND OF THE INVENTION

Certain embodiments of the present invention are directed to computer technology. More particularly, some embodiments of the invention provide systems and methods for network technology. Merely by way of example, some embodiments of the invention have been applied to messages. But it would be recognized that the invention has a much broader range of applicability.

Microblog, as an emerging application for information sharing and spreading in recent years, has become more and more popular. Microblog messages are often displayed in a reverse chronological order. For example, microblog messages are inserted into a timeline of an audience which displays the microblog messages received by the user in a reverse chronological order. Time periods when users log into a microblog application are fragmentized. For example, a user may log in the microblog application many times a day, read latest messages and stay for a short period of time. Thus, relatively old microblog messages on the timeline are likely to be buried in numerous microblog messages and are not read by the user. However, of these buried messages, there may be very important or urgent messages for the user. In addition, the buried messages occupy a lot of cache resources of the client.

Currently, a specific message is often sent to a receiving user many times during different time periods. However, such an approach may increase the processing load of a message sending terminal and storing many identical messages on the client may result in waste of the caching resources of the client.

Hence it is highly desirable to improve the techniques for sending messages.

### BRIEF SUMMARY OF THE INVENTION

According to one embodiment, a method is provided for sending messages. For example, a receiving user list corresponding to a specific message to be sent is acquired; a first timeline refresh request associated with a first receiving user in the receiving user list is received; and upon the capture of the first timeline refresh request, the specific message is sent to a client associated with the first receiving user that refreshes a timeline.

According to another embodiment, a method is provided for receiving messages. For example, a timeline refresh request is sent to a server; and a specific message received from the server is displayed according to a first time associated with the specific message in a timeline of a receiving user.

According to yet another embodiment, a server includes: a capturing module configured to acquire a receiving user list corresponding to a specific message to be sent and capture a first timeline refresh request associated with a first receiving user in the receiving user list; and a message sending module configured to, upon the capture of the first timeline refresh request, send the specific message to a client associated with the first receiving user that refreshes a timeline.

In one embodiment, a client includes: a sending module configured to send a timeline refresh request to a server; and a display module configured to display a specific message received from the server according to a first time associated with the specific message in a timeline of a receiving user.

In another embodiment, a message sending system includes: a server and a client. The server includes: a capturing module configured to acquire a receiving user list corresponding to a specific message to be sent and capture a timeline refresh request associated with a receiving user in the receiving user list; and a message sending module configured to, upon the capture of the timeline refresh request, send the specific message to the client associated with the receiving user that refreshes a timeline. The client includes: a sending module configured to send the timeline refresh request to the server; and a display module configured to display the specific message received from the server according to a first time associated with the specific message in a timeline of the receiving user.

In yet another embodiment, a non-transitory computer readable storage medium includes programming instructions for sending messages. The programming instructions are configured to cause one or more data processors to execute certain operations. For example, a receiving user list corresponding to a specific message to be sent is acquired; a first timeline refresh request associated with a first receiving user in the receiving user list is received; and upon the capture of the first timeline refresh request, the specific message is sent to a client associated with the first receiving user that refreshes a timeline.

In yet another embodiment, a non-transitory computer readable storage medium includes programming instructions for receiving messages. The programming instructions are configured to cause one or more data processors to execute certain operations. For example, a timeline refresh request is sent to a server; and a specific message received from the server is displayed according to a first time associated with the specific message in a timeline of a receiving user.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for sending messages according to one embodiment of the present invention.

FIG. 2 is a simplified diagram showing a method for receiving messages according to another embodiment of the present invention.

FIG. 3 is a simplified diagram showing a server for sending messages according to one embodiment of the present invention.

FIG. 4 is a simplified diagram showing a client according to one embodiment of the present invention.

FIG. 5 is a simplified diagram showing an application scenario for message sending according to one embodiment of the present invention.

### DETAILED DESCRIPTION OF THE INVENTION

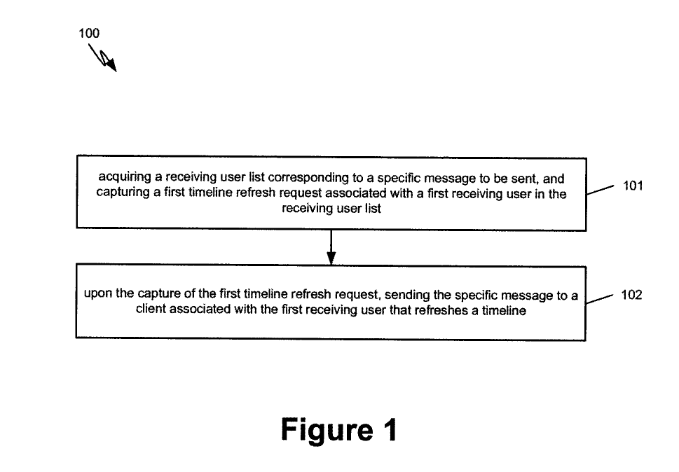

FIG. 1 is a simplified diagram showing a method for sending messages according to one embodiment of the present invention. The diagram is merely an example, which should not unduly limit the scope of the claims. One of ordinary skill in the art would recognize many variations, alternatives, and modifications. The method 100 includes at least processes 101-102.

According to one embodiment, the process 101 includes: acquiring a receiving user list corresponding to a specific message to be sent and capturing a first timeline refresh request associated with a first receiving user in the receiving user list. For example, the method 100 is implemented via independent hardware in a background message server. As an example, operations associated with the process 101 includes: the message server acquires the receiving user list corresponding to the specific message and captures the first timeline refresh request of the first receiving users in the receiving user list when the specific message to be sent is available.

According to another embodiment, all user identifications and corresponding listening user lists thereof are stored in the message server. As an example, the process for acquiring a receiving user list corresponding to a specific message to be sent (e.g., using the message server) includes: acquiring a sending user identification associated with the specific message, searching for a listening user list associated with a sending user based on at least information associated with the sending user identification, and adopting the listening user list as the receiving user list corresponding to the specific message, wherein one or more receiving user identifications are included in the receiving user list.

According to yet another embodiment, the user identifications and the corresponding listening user lists thereof are stored in a special database external to the message server. For example, the process for acquiring a receiving user list corresponding to a specific message to be sent (e.g., using the message server) includes: acquiring a sending user identification associated with the specific message, searching for a listening user list associated with a sending user in the database based on at least information associated with the sending user identification, and adopting the listening user list as the receiving user list corresponding to the specific message, wherein one or more receiving user identifications are included in the receiving user list. The specific message includes a specific identification, so that the message server can identify the specific message and execute the method 100, according to certain embodiments.

In one embodiment, the process 102 includes: upon the capture of the first timeline refresh request, sending the specific message to a client associated with the first receiving user that refreshes a timeline. For example, the method 100 is implemented via independent hardware in a background message server. As an example, operations associated with the process 102 includes: the specific message is sent to the client associated with the first receiving user that refreshes the timeline when the message server captures the first timeline refresh request of the first receiving user. As another example, the first receiving user currently refreshing the timeline corresponds to a receiving user that is currently online.

In another embodiment, the upon the capture of the first timeline refresh request, sending the specific message to a client associated with the first receiving user that refreshes a timeline includes: upon the capture of the first timeline refresh request, acquiring a first user identification associated with the first timeline refresh request; matching the first user identification with the receiving user list; and in response to the first user identification existing in the receiving user list, determining that the first timeline refresh request associated with the first receiving user is captured and sending the specific message to the client.

In yet another embodiment, after the specific message is sent to the first receiving user (e.g., currently online) that is currently refreshing the timeline, the first user identification of the first receiving user is deleted from the receiving user list. Thus, repeated sending of the specific message to the first receiving user is avoided, according to some embodiments. For example, when the fast user identification is matched with the receiving user list, if the first user identification is not in the receiving user list, it indicates that the first receiving user that executes the timeline refresh operation is not one of the receiving users, and thus the specific message does not need to be sent to the first receiving user. In another example, if the first user identification is deleted from the receiving user list, the specific message does not need to be repeatedly sent to the first receiving user as well.

According to one embodiment, before the receiving user list corresponding to the specific message to be sent is acquired, the method 100 further includes: presetting a time point or a time period for capturing the first timeline refresh request. For example, the capturing a first timeline refresh request associated with a first receiving user in the receiving user list includes: capturing the first timeline refresh request associated with the first receiving user at the preset time point; or capturing the first timeline refresh request associated with the first receiving user according to the preset time period. As an example, discrete time points for capturing the timeline refresh operations of the first receiving user are preset as 10:00, 11:00, 12:00 and 13:00, and then the timeline refresh operations of the first receiving user are to be captured at these time points 10:00, 11:00, 12:00 and 13:00. As another example, a time period for capturing the timeline refresh operations of the first receiving user is preset as 1 hour beginning at 8:00. In another example, the timeline refresh operations of the first receiving user are to be captured at 8:00, and later, the timeline refresh operations of the user are to be captured every other hour (e.g., at 9:00,10:00, 11:00, 12:00, etc.).

According to another embodiment, the number of the time points may be properly adjusted according to the number of the receiving users in the receiving user list. For example, if the number of the receiving users in the receiving user list is too large, the number of the time points may be properly increased. That is, the timeline refresh operations of the receiving users are to be captured at more time points so as to ensure that the specific message is properly sent. In another example, if the number of the receiving users in the receiving user list is small, the number of the time points may be properly decreased while ensuring that the specific message is properly sent so as to reduce system burden.

According to yet another embodiment, the length of the time period may be also properly adjusted according to the number of the receiving users in the receiving user list. For example, if the number of the receiving users in the receiving user list is too large, the time period may be properly shortened (e.g., setting the time period to 5 min or 10 min). That is, the frequency for capturing the timeline refresh operations of the user is increased so as to ensure the specific message is properly sent. In another example, if the number of the receiving users in the receiving user list is small, the time period may be properly prolonged (e.g., setting the time period to 1 hour or 2 hours) while ensuring that the specific message is properly sent so as to reduce system burden.

In one embodiment, the method 100 further includes: in response to the specific message being sent to all receiving users in the receiving user list, stopping capturing one or more second timeline refresh requests associated with one or more second receiving users in the receiving user list, and stopping sending the specific message. For instance, after the specific message is sent to the corresponding receiving users in the receiving user list, the corresponding receiving user identifications are deleted from the receiving user list. As an example, when the receiving user list is empty, the specific message has been sent to all receiving users in the receiving user list.

In another embodiment, a termination time may be preset. For example, the method 100 further includes: in response to the preset termination time being reached, stopping capturing one or more second timeline refresh requests associated with one or more second receiving users in the receiving user list; and stopping sending the specific message. For instance, if the termination time of the operations is set at 3:00, capturing the timeline refresh operations of the users is stopped and sending the specific message is stopped when the time at 3:00 is reached. In another example, the termination time of the operation is set as 12 hours after one or more timeline refresh operations of the users are captured for the first time. Then, capturing the timeline refresh operations of the users is stopped and sending the specific message is stopped when the corresponding termination time is reached, according to some embodiments.

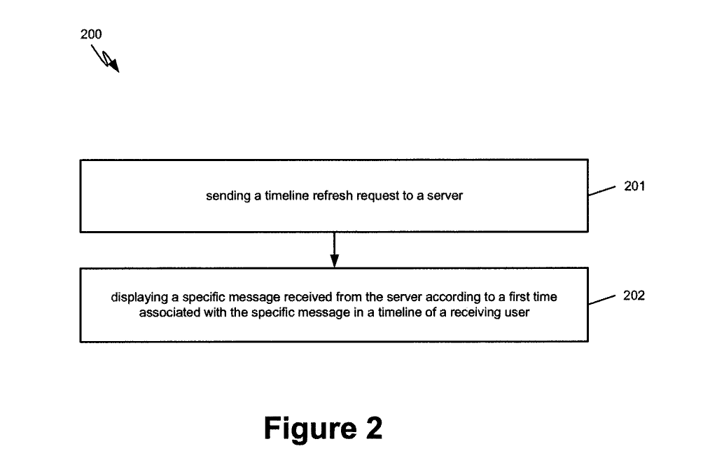

FIG. 2 is a simplified diagram showing a method for receiving messages according to another embodiment of the present invention. The diagram is merely an example, which should not unduly limit the scope of the claims. One of ordinary skill in the art would recognize many variations, alternatives, and modifications. The method 200 includes at least processes 201-202.

According to one embodiment, the process 201 includes: sending a timeline refresh request to a server. For example, when the user executes the timeline refresh operations via a client, the client sends the timeline refresh requests to a message server. In another example, if the user serves as the receiving user of a certain specific message, the message server sends the specific message to the client where the receiving user is located upon the capture of the timeline refresh request of the receiving user.

According to another embodiment, the process 202 includes: displaying a specific message received from the server according to a first time associated with the specific message in a timeline of a receiving user. For example, the specific message sent by the message server is received by the client where the receiving user of the specific message is located, and is then stored into a cache thereof. As an example, the first time is identified for the specific message, and corresponds to the time when the specific message is received.

According to yet another embodiment, after the message server sends the specific message to a currently online receiving user, the specific message is displayed on the client where the receiving user is located, and the time of the specific message corresponds to a latest time. Since messages are displayed in a reverse chronological order, the specific message can be ensured to be displayed at the head of the timeline and is easily read by the user, according to some embodiments. The sending mechanism of the specific message associated with the method 100 and/or the method 200 is different from a sending mechanism of a normal message, according to certain embodiments. For example, a normal message is sent to a receiving user when the normal message is generated, and is cached at a client according to a timeline. Then, when the receiving user refreshes the timeline, the normal message is called out from the cache. In contrast, according to the method 100 and/or the method 200, a specific message is not sent to the receiving user upon its generation, according to some embodiments. Instead, an online status of the receiving user is captured, and then the specific message is pushed to a currently online user so as to ensure that the specific message is displayed at the head of the timeline, according to certain embodiments.

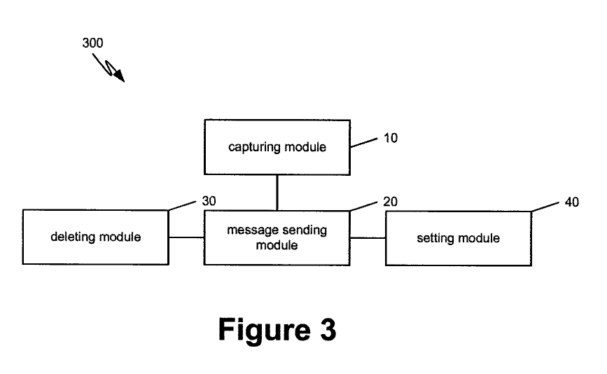

FIG. 3 is a simplified diagram showing a server for sending messages according to one embodiment of the present invention. The diagram is merely an example, which should not unduly limit the scope of the claims. One of ordinary skill in the art would recognize many variations, alternatives, and modifications. The server 300 includes a capturing module 10, a message sending module 20, a deleting module 30, and a setting module 40.

According to one embodiment, the capturing module 10 is configured to acquire a receiving user list corresponding to a specific message to be sent and capture a first timeline refresh request associated with a first receiving user in the receiving user list. For example, the message sending module 20 is configured to, upon the capture of the first timeline refresh request, send the specific message to a client associated with the first receiving user that refreshes a timeline. As an example, the capturing module 10 is further configured to acquire a sending user identification associated with the specific message, search for a listening user list associated with a sending user based on at least information associated with the sending user identification, and adopt the listening user list as the receiving user list corresponding to the specific message, wherein one or more receiving user identifications are included in the receiving user list.

According to another embodiment, the message sending module 20 is further configured to: upon the capture of the first timeline refresh request, acquire a first user identification associated with the first timeline refresh request; match the first user identification with the receiving user list; in response to the first user identification existing in the receiving user list, determine that the first timeline refresh request associated with the first receiving user is captured; and send the specific message to the clients. For example, the deleting module 30 is connected to the message sending module 20 and is configured to delete the receiving user identification from the receiving user list after the message sending module 20 sends the specific message to the first receiving user (e.g., currently online). Thus, repeated sending of the specific message to the first receiving user is avoided, according to some embodiments. For example, when the first user identification is matched with the receiving user list, if the first user identification is not in the receiving user list, it indicates that the first receiving user that executes the timeline refresh operation is not one of the receiving users, and thus the specific message does not need to be sent to the first receiving user. In another example, if the first user identification is deleted from the receiving user list, the specific message does not need to be repeatedly sent to the first receiving user as well.

According to yet another embodiment, the setting module 40 connected to the message sending module 20 is configured to preset one or more time points or one or more time periods for capturing the first timeline refresh request. For example, the message sending module 20 is further configured to capture the first timeline refresh request associated with the first receiving user at the preset time points or capture the first timeline refresh request associated with the first receiving user according to the preset time periods. As an example, the setting module 40 presets discrete time points for capturing the timeline refresh operations of the first receiving user as 10:00, 11:00, 12:00 and 13:00, and then the message sending module 20 captures the timeline refresh operations of the first receiving user at these time points 10:00, 11:00, 12:00 and 13:00. As another example, the setting module 40 presets a time period for capturing the timeline refresh operations of the first receiving user to be 1 hour beginning at 8:00. In another example, the message sending module 20 captures the timeline refresh operations of the first receiving user at 8:00, and later captures the timeline refresh operations of the user every other hour (e.g., at 9:00, 10:00, 11:00, 12:00, etc.).

According to another embodiment, the number of the time points may be properly adjusted according to the number of the receiving users in the receiving user list. For example, if the number of the receiving users in the receiving user list is too large, the number of the time points may be properly increased. That is, the timeline refresh operations of the receiving users are to be captured at more time points so as to ensure that the specific message is properly sent. In another example, if the number of the receiving users in the receiving user list is small, the number of the time points may be properly decreased while ensuring that the specific message is properly sent so as to reduce system burden.

According to yet another embodiment, the length of the time period may be also properly adjusted according to the number of the receiving users in the receiving user list. For example, if the number of the receiving users in the receiving user list is too large, the time period may be properly shortened. That is, the frequency for capturing the timeline refresh operations of the user is increased so as to ensure the specific message is properly sent. In another example, if the number of the receiving users in the receiving user list is small, the time period may be properly prolonged while ensuring that the specific message is properly sent so as to reduce system burden.

In one embodiment, the message sending module 20 is further configured to, in response to the specific message being sent to all receiving users in the receiving user list, stop capturing one or more second timeline refresh requests associated with one or more second receiving users in the receiving user list, and stop sending the specific message. For instance, after the specific message is sent to the corresponding receiving users in the receiving user list, the deleting module 30 deletes the corresponding receiving user identifications from the receiving user list. As an example, when the receiving user list is empty, the specific message has been sent to all receiving users in the receiving user list.

In another embodiment, the setting module 40 is configured to preset a termination time. For example, the message sending module 20 is further configured to, in response to the preset termination time being reached, stop capturing one or more second timeline refresh requests associated with one or more second receiving users in the receiving user list and stop sending the specific message.

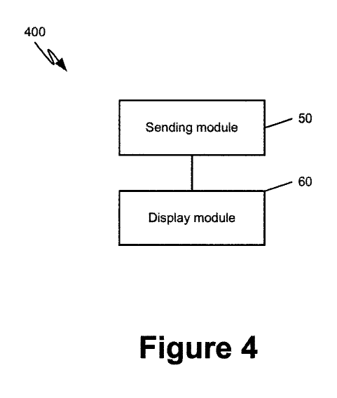

FIG. 4 is a simplified diagram showing a client according to one embodiment of the present invention. The diagram is merely an example, which should not unduly limit the scope of the claims. One of ordinary skill in the art would recognize many variations, alternatives, and modifications. The client 400 includes a sending module 50, and a display module 60.

According to one embodiment, the sending module 50 is configured to send a timeline refresh request to a server. For example, the display module 60 is configured to display a specific message received from the server according to a first time associated with the specific message in a timeline of a receiving user. The first time associated with the specific message in the timeline of the receiving user corresponds to a time when the specific message is received, according to certain embodiments. A message sending system may include the server 300 and the client 400, according to some embodiments.

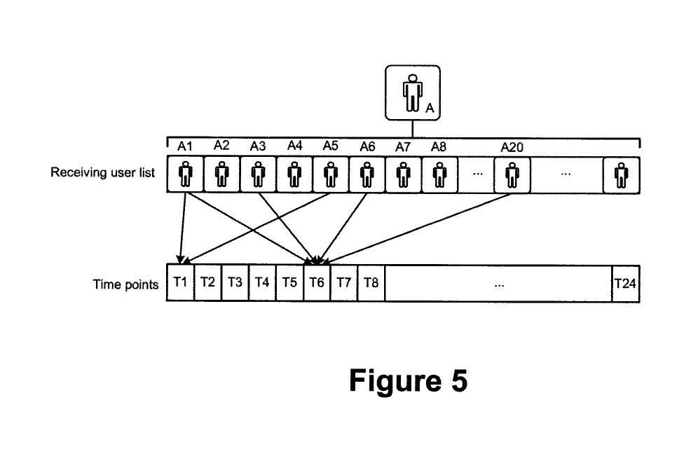

FIG. 5 is a simplified diagram showing an application scenario for message sending according to one embodiment of the present invention. The diagram is merely an example, which should not unduly limit the scope of the claims. One of ordinary skill in the art would recognize many variations, alternatives, and modifications.

As shown in FIG. 5, a microblog user A has 100 listening users, according to some embodiments. For example, a listening user list includes 100 listening users. As an example, a specific message of the user A is sent at 24 time points (e.g., T1-T24). The 24 time points cover a whole day and are uniformly distributed throughout the day, according to certain embodiments. For example, T1=1:00, T2=2:00, T3=3:00, . . . , and T24=24:00.

According to one embodiment, a microblog message is sent to one or more users. For example, a message server acquires a specific message of the user A and an identification of the user A, searches for a listening user list of the user A according to the identification of the user A and takes the searched listening user list of the user A as a receiving user list corresponding to the specific message. As an example, the message server captures a timeline refresh operation of the user at a T1 moment according to a preset time point, and detects that two users are online. As another example, the message server acquires the identifications of the two users, matches the acquired user identifications with the user identifications in the receiving user list, and discovers that the two user identifications are contained in the receiving user list (e.g., users A1 and A5). As yet another example, the message server determines that the receiving users A1 and A5 are online, sends the specific message to the receiving users A1 and A5, and simultaneously deletes the identifications of the receiving users A1 and A5 in the receiving user list. Operations at each subsequent time point are similar to those at the T1 time point, according to certain embodiments.

Upon capturing the timeline refresh operation of the user at a T6 moment, the message server detects that four users are online (e.g., users A1, A3, A6 and A20), and acquires the identifications of the four users, according to some embodiments. For example, the message server matches the acquired user identifications with the user identifications in the receiving user list, and discovers that the identifications of the users A3, A6 and A20 are contained in the receiving user list and the identification of the user A1 is not in the receiving user list. That is because the specific message has been sent to the user A1 at the previous T1 moment and the identification of the user A1 is deleted from the receiving user list, according to certain embodiments. For example, the message server sends the specific message to the receiving users A3, A6 and A20, and simultaneously deletes the identifications of the users A3, A6 and A20 in the receiving user list. The specific message is sent to only the currently online receiving users, and the specific message is not sent to the currently offline receiving users until the offline receiving users get online, so as to optimize the message sending mechanism, according to certain embodiments. For example, messages that are important or urgent to the user may not be buried by a lot of other messages and may be read by the user. In another example, the important or urgent messages are sent to all corresponding receiving users, and the user experience is improved. In yet another example, through the optimization of the message sending mechanism, the processing load of a message sending terminal can be reduced and the cache resources of the client can be better utilized.

According to one embodiment, a method is provided for sending messages. For example, a receiving user list corresponding to a specific message to be sent is acquired; a first timeline refresh request associated with a first receiving user in the receiving user list is received; and upon the capture of the first timeline refresh request, the specific message is sent to a client associated with the first receiving user that refreshes a timeline. For example, the method is implemented according to at least FIG. 1.

According to another embodiment, a method is provided for receiving messages. For example, a timeline refresh request is sent to a server; and a specific message received from the server is displayed according to a first time associated with the specific message in a timeline of a receiving user. For example, the method is implemented according to at least FIG. 2.

According to yet another embodiment, a server includes: a capturing module configured to acquire a receiving user list corresponding to a specific message to be sent and capture a first timeline refresh request associated with a first receiving user in the receiving user list; and a message sending module configured to, upon the capture of the first timeline refresh request, send the specific message to a client associated with the first receiving user that refreshes a timeline. As an example, the server includes: one or more data processors and a computer-readable storage medium, where one or more of the capturing module, and the message sending module are stored in the storage medium and configured to be executed by the one or more data processors. For example, the server is implemented according to at least FIG. 3.

In one embodiment, a client includes: a sending module configured to send a timeline refresh request to a server; and a display module configured to display a specific message received from the server according to a first time associated with the specific message in a timeline of a receiving user. As an example, the server includes: one or more data processors and a computer-readable storage medium, where one or more of the sending module, and the display module are stored in the storage medium and configured to be executed by the one or more data processors. For example, the client is implemented according to at least FIG. 4.

In another embodiment, a message sending system includes: a server and a client. The server includes: a capturing module configured to acquire a receiving user list corresponding to a specific message to be sent and capture a timeline refresh request associated with a receiving user in the receiving user list; and a message sending module configured to, upon the capture of the timeline refresh request, send the specific message to the client associated with the receiving user that refreshes a timeline. The client includes: a sending module configured to send the timeline refresh request to the server; and a display module configured to display the specific message received from the server according to a first time associated with the specific message in a timeline of the receiving user. For example, the system is implemented according to at least FIG. 3 and/or FIG. 4.

In yet another embodiment, a non-transitory computer readable storage medium includes programming instructions for sending messages. The programming instructions are configured to cause one or more data processors to execute certain operations. For example, a receiving user list corresponding to a specific message to be sent is acquired; a first timeline refresh request associated with a first receiving user in the receiving user list is received; and upon the capture of the first timeline refresh request, the specific message is sent to a client associated with the first receiving user that refreshes a timeline. For example, the storage medium is implemented according to at least FIG. 1.

In yet another embodiment, a non-transitory computer readable storage medium includes programming instructions for receiving messages. The programming instructions are configured to cause one or more data processors to execute certain operations. For example, a timeline refresh request is sent to a server; and a specific message received from the server is displayed according to a first time associated with the specific message in a timeline of a receiving user. For example, the storage medium is implemented according to at least FIG. 2.

The above only describes several scenarios presented by this invention, and the description is relatively specific and detailed, yet it cannot therefore be understood as limiting the scope of this invention. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

1. A method for sending messages, the method comprising:
acquiring a receiving user list corresponding to a specific message to be sent;
capturing a first timeline refresh request associated with a first receiving user in the receiving user list; and
upon the capture of the first timeline refresh request, sending the specific message to a client associated with the first receiving user that refreshes a timeline.

2. The method of claim 1, wherein the acquiring a receiving user list corresponding to a specific message to be sent includes:
acquiring a sending user identification associated with the specific message;
searching for a listening user list associated with a sending user based on at least information associated with the sending user identification; and
adopting the listening user list as the receiving user list corresponding to the specific message, wherein one or more receiving user identifications are included in the receiving user list.

3. The method of claim 2, wherein the upon the capture of the first timeline refresh request, sending the specific message to a client associated with the first receiving user that refreshes a timeline includes:
upon the capture of the first timeline refresh request, acquiring a first user identification associated with the first receiving user;
matching the first user identification with the receiving user list;
in response to the first user identification existing in the receiving user list,
determining that the first timeline refresh request associated with the first receiving user is captured; and
sending the specific message to the client.

4. The method of claim 3, further comprising:
in response to the specific message being sent to the client, deleting the first user identification from the receiving user list.

5. The method of claim 1, further comprising:
presetting one or more time points or one or more time periods for capturing the first timeline refresh request;
wherein the capturing a first timeline refresh request associated with a first receiving user in the receiving user list includes:
capturing the first timeline refresh request associated with the first receiving user at the preset time points; or
capturing the first timeline refresh request associated with the first receiving user according to the preset time periods.

6. The method of claim 5, further comprising:
in response to the specific message being sent to all receiving users in the receiving user list,
stopping capturing one or more second timeline refresh requests associated with one or more second receiving users in the receiving user list; and
stopping sending the specific message.

7. The method of claim 5, further comprising:
in response to a preset termination time being reached,
stopping capturing one or more second timeline refresh requests associated with one or more second receiving users in the receiving user list; and
stopping sending the specific message.

8. A method for receiving messages, the method comprising:
sending a timeline refresh request to a server; and
displaying a specific message received from the server according to a first time associated with the specific message in a timeline of a receiving user.

9. The method of claim 8, wherein the first time corresponds to a time when the specific message is received.

10. A server comprising:
a capturing module configured to acquire a receiving user list corresponding to a specific message to be sent and capture a first timeline refresh request associated with a first receiving user in the receiving user list; and
a message sending module configured to, upon the capture of the first timeline refresh request, send the specific message to a client associated with the first receiving user that refreshes a timeline.

11. The server of claim 10, wherein the capturing module is further configured to acquire a sending user identification associated with the specific message, search for a listening user list associated with a sending user based on at least information associated with the sending user identification, and adopt the listening user list as the receiving user list corresponding to the specific message, wherein one or more receiving user identifications are included in the receiving user list.

12. The server of claim 10, wherein the message sending module is further configured to:
upon the capture of the first timeline refresh request, acquire a first user identification associated with the first timeline refresh request;
match the first user identification with the receiving user list;
in response to the first user identification existing in the receiving user list, determine that the first timeline refresh request associated with the first receiving user is captured; and
send the specific message to the clients.

13. The server of claim 11, further comprising:
a deleting module configured to, in response to the specific message being sent to the client, delete the receiving user identification from the receiving user list.

14. The server of claim 10, further comprising:
a setting module configured to preset one or more time points or one or more time periods for capturing the first timeline refresh request;
wherein the message sending module is further configured to capture the first timeline refresh request associated with the first receiving user at the preset time points or capture the first timeline refresh request associated with the first receiving user according to the preset time periods.

15. The server of claim 14, wherein the message sending module is further configured to, in response to the specific message being sent to all receiving users in the receiving user list, stop capturing one or more second timeline refresh requests associated with one or more second receiving users in the receiving user list and stop sending the specific message.

16. The server of claim 14, wherein:
the setting module is further configured to preset a termination time; and
the message sending module is further configured to, in response to the preset termination time being reached,
stop capturing one or more second timeline refresh requests associated with one or more second receiving users in the receiving user list; and
stop sending the specific message.

17. The server of claim 10, further comprising:
one or more data processors; and
a computer-readable storage medium;
wherein one or more of the capturing module, and the message sending module are stored in the storage medium and configured to be executed by the one or more data processors.

18. A client comprising:
a sending module configured to send a timeline refresh request to a server; and
a display module configured to display a specific message received from the server according to a first time associated with the specific message in a timeline of a receiving user.

19. The client of claim 18, wherein the first time corresponds to a time when the specific message is received.

20. The client of claim 18, further comprising:
one or more data processors; and
a computer-readable storage medium;
wherein one or more of the sending module, and the display module are stored in the storage medium and configured to be executed by the one or more data processors.

21. A message sending system comprising:
a server; and
a client;
wherein the server includes:
a capturing module configured to acquire a receiving user list corresponding to a specific message to be sent and capture a timeline refresh request associated with a receiving user in the receiving user list; and
a message sending module configured to, upon the capture of the timeline refresh request, send the specific message to the client associated with the receiving user that refreshes a timeline;
wherein the client includes:
a sending module configured to send the timeline refresh request to the server; and
a display module configured to display the specific message received from the server according to a first time associated with the specific message in a timeline of the receiving user.

22. A non-transitory computer readable storage medium comprising programming instructions for sending messages, the programming instructions configured to cause one or more data processors to execute operations comprising:
acquiring a receiving user list corresponding to a specific message to be sent;
capturing a timeline refresh request associated with a first receiving user in the receiving user list; and
upon the capture of the timeline refresh request, sending the specific message to a client associated with the first receiving user that refreshes a timeline.

23. A non-transitory computer readable storage medium comprising programming instructions for receiving messages, the programming instructions configured to cause one or more data processors to execute operations comprising:
sending a timeline refresh request to a server; and
displaying a specific message received from the server according to a first time associated with the specific message in a timeline of a receiving user.
